(19) United States
(12) Patent Application Publication
(10) Pub. No.: US 2009/0013212 A1
(43) Pub. Date: Jan. 8, 2009

(54) System and Method for Computer Data Recovery

(75) Inventor: Jonathan LYSTER, Powell River (CA)

Correspondence Address: LANG MICHENER, BCE PLACE, P.O. BOX 747, SUITE 2500, 181 BAY STREET, TORONTO, ON, M5J 2T7, CA

(73) Assignee: TUGBOAT ENTERPRISES LTD., Powell River (CA)

(21) Appl. No.: 12/168,081

(22) Filed: Jul. 4, 2008

(30) Foreign Application Priority Data
Jul. 6, 2007 (CA) 2593169

(51) Int. Cl. G06F 11/07

(52) U.S. Cl. 714/6; 714/E11.023

(57) ABSTRACT

The invention consists of a method of data recovery for a computer system, the steps comprising: a) initializing hardware associated with the computer system, the hardware including a hard drive, and a minimum of 32 MB of RAM; b) initializing network devices and connections associated with the computer system; c) scanning and identifying partitions on any hard drives connected to the computer system; d) recovering data from the hard drives by making all the data on the computer system available over the network as a network share resembling a file server; and e) copying the recovered data over the network connection to a recovery hard drive.

### FIELD OF THE INVENTION

The present invention relates to the field of computer data recovery. In particular, it relates to a system and method for recovering and/or restoring data from a non-operational computer system.

### BACKGROUND OF THE INVENTION

One of the more serious problems that arises in the day-to-day use of computers is the response to a system failure, either hardware or software. While most problems can be resolved in time, for systems that are in continual use, that time may not be available. Furthermore, other related systems may require access to the data contained on the damaged system. It then becomes necessary to find a method of accessing the data on a failed system before the problem is resolved or possibly even diagnosed.

Many types of backup and system restoration products are commercially available. The most commonly recognized and known is an “undelete” tool, which permits a user to recover files which have been erased (accidentally or intentionally). Basic undelete tools are available for most modern operating systems (OS), with more advanced versions capable of recovering entire hard drives or other storage devices. One drawback to undelete tools is that they are typically restricted to operating under a specific OS, and require that the OS be available and functional. Situations where the OS itself has been deleted or corrupted, or where more aggressive deletion mechanisms have been used, are generally beyond the scope of ability of such undelete tools.

Another type of restoration product is the hard-drive repair utility. These utilities scan the hard-drive (or, theoretically, other storage media) for damaged data sectors and can be used to attempt data recovery from the storage media, including the damaged sectors, as well as marking such sectors to avoid further use of them in the future. The scan can take several hours or more to run, given the size of modern hard drives, and is only effective at addressing data corruption due to bad sectors. Other problems are not addressed, leading to wasted time and effort if the data problem arises from a different source.

Yet another alternative for restoring and/or repairing a non-functioning system is to use a boot disk or even a full OS distribution CD. One example is Knoppix, which provides a program that runs from a CD. The difficulty with CD boot disks is that they use considerable memory and require the hardware in the computer to be in working order in order to access the hard drive. Thus, a failure in a video card, RAM chip or other component can prevent the OS from running, eliminating it as a recovery option until the hardware problem is addressed.

There are also forensic data recovery services which are used to recover data from hard drives which have been subject to physical damage from fire, flood, power surges or other events. These services require trained personnel who disassemble the physical hard drive in a clean room and extract the data directly from the exposed discs. The high cost and specialized nature of these services makes them generally unsuitable for use by individuals or small business. Additionally, the extensive time required to perform the data recovery operation prevents it from being effective in emergency situations where the recovered data is required on a same-day basis.

A common limitation of the majority of existing backup and data recovery software is heavy dependency on the OS and the hardware of the computer system. As a result, they are limited in scope of application and subject to failure in situations where the problem is not related to hard drive corruption.

In general, there is a need for a utility that allows for the rapid recovery of critical data from a non-functioning computer system in time-critical scenarios, without the necessity of restoring the entire computer system.

It is an object of this invention to partially or completely fulfill one or more of the above-mentioned needs.

### SUMMARY OF THE INVENTION

The invention consists of a method of data recovery for a computer system, the steps comprising: a) initializing hardware associated with the computer system, the hardware including a hard drive, and a minimum of 32 MB of operational RAM; b) initializing network devices and connections associated with the computer system; c) scanning and identifying partitions on any hard drives connected to the computer system; d) recovering data from the hard drives by making all the data on the computer system available over the network as a network share resembling a file server; and e) copying the recovered data over the network connection to a recovery hard drive.

The method may further include an additional step of scanning for viruses, either the entire partitions prior to recovery, or each file during recovery.

Preferably, the method is implemented as a software distribution.

The invention further includes a system of data recovery according to the present method, as well a machine-readable media containing software for executing the method.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a flow chart showing the steps of the data recovery process according to the present invention;

FIG. 2 is a flow chart showing the steps of the hardware scanning process;

FIG. 3 is a flow chart showing the steps in configuring the network connection;

### DETAILED DESCRIPTION OF THE PREFERRED EMBODIMENTS

The inventive system and method presented herein consists of a system and method of data recovery which operates with reduced hardware requirements and is capable of rapidly recovering specific data from a non-functioning computer system, independently of the nature of computer system or the reason for failure of the software or certain hardware components.

The system consists of a software application which is capable of initialization from a compact disc (CD), USB drive or other portable computer-readable storage medium. Currently, the preferred system is implemented as a bootable CD, however the development of bootable USB drives and similar devices projected for the future allows for their use as alternatives and the implementation of the system should reflect the current state of available portable medium technology. Moreover, as is generally understood in the art, computer-readable storage media can include transient or temporary media, such as computer RAM and Internet data packets, for use in copying, transferring and/or providing the software application to the end user.

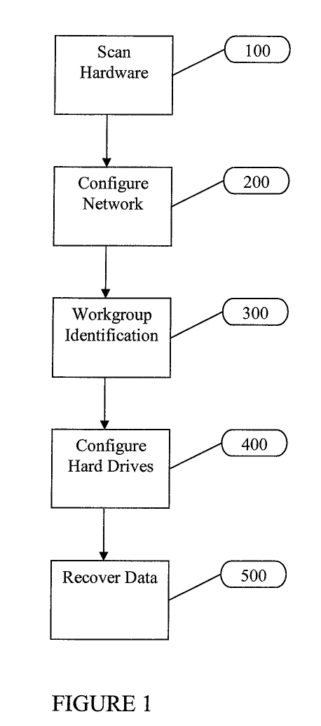

The system and method operate through a five step process as shown in FIG. 1. First (step 100), the hardware of the failed computer is scanned and initialized. Once completed, the network is configured for the computer (step 200) and associated workgroups are identified (Step 300). Next, the hard drives are scanned and partitions identified (step 400). Once the preceding steps are completed, the data on the failed computer can be recovered (step 500) over the network, including transfer to a USB-connected hard drive on the failed computer.

When a computer system crashes and cannot be restarted, the data recovery process is begun by inserting the CD into the system and re-booting directly from the CD. On booting, the application initializes the hardware (step 100), but in a modified fashion, so that only the hardware required for the data recovery process is activated. Generally, this hardware includes the hard drive, the video card, the keyboard/mouse input devices, and a network card. Other non-essential hardware, such as sound cards, alternative input devices, modems, disk drives, etc. are not initialized, so that a problem with any of the non-essential hardware will not inhibit the data recovery process. Additionally, the removal of these non-essential elements from the initialization process reduces the system requirements.

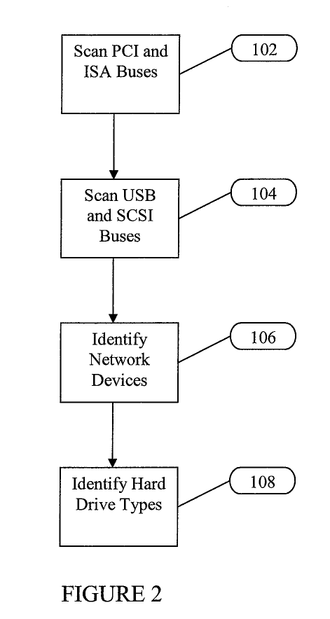

The hardware initialization process, as shown in FIG. 2, first scans and loads the appropriate drivers for the PCI and ISA buses (step 102), most often used by video cards, then scans and load drivers for the USB and SCSI buses (step 104), most often used by hard drives. Connected network devices are identified (step 106) and their drivers loaded. Finally, the hard drive types are identified (step 108), including any USB-connected hard drives.

The application is designed to run in 16-color VGA mode, which is the base-level mode used by all current and the majority of prior generation video cards. By limiting the video card to basic mode, advanced drivers are not required, eliminating compatibility issues. Similarly, by minimizing the RAM footprint of the application to an amount substantially lower than the amount in the system, preferably to 32 MB (most modern computers have at least 512 MB, older ones at least 128 MB), the risk of encountering a system failure due to a RAM defect is greatly reduced.

Furthermore, it can become readily apparent if the reason for the system failure is related to video card or RAM failure. In either of those cases, the failed card or RAM slice can be removed, and temporarily replaced with a base model (for a video card) or ignored (for a RAM slice) and data recovery can then proceed, whereas the main OS would not operate under the reduced system capabilities.

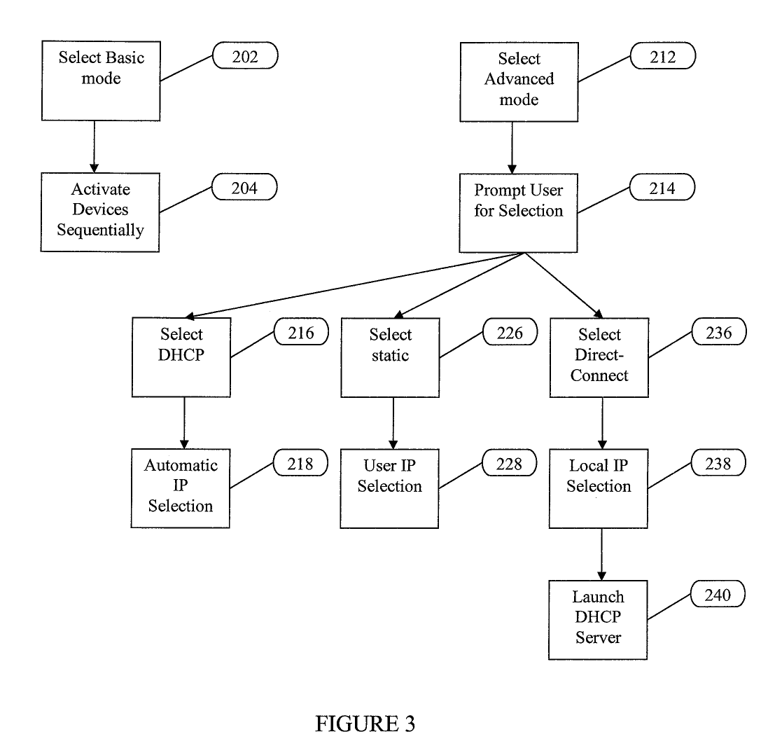

Once the hardware is initialized, the network connections are configured (step 200) and verified as functional. Network configuration can proceed in either a basic (automatic) or advanced (user-controlled) mode, following the steps shown in FIG. 3. In basic mode (202), the system activates each network device sequentially (204) and attempts to obtain an IP address.

In advanced mode (212) the user is prompted (214) for a choice of network type: DHCP (216), static (226) or direct-cable connect (236). Once selected, an IP address is established according to the chosen type. For DHCP, the system attempts to obtain an IP address automatically from the network (218). For static, the user is asked to set up an IP address (228). For direct-connect, a local IP address is configured automatically (238) and a DHCP server component is launched (240), providing the recovery computer with an address. At the end of any of these processes, the network connection is available for the transfer of the recovered data.

Once the network is configured (step 200), the workgroups associated with the network are identified (step 300). This step proceeds automatically by probing the network for existing workgroups and domains. If only one group is found, the system adds itself, and thus the failed computer, to the group. If multiple groups are found, the user is prompted to select a group. At this stage, the system has started the failed computer, connected it to the network, and made it available for access from another recovery computer over the network connection.

With the hardware and network activated, the hard drives are scanned and partitions identified (step 400). At this stage, the hard drive scanned can include hard drives which are connected over the network connections and/or over USB connections. The available partitions are then presented to the user, preferably as read-only, for data access and recovery.

The user can recover data immediately, and, if desired, engage a virus-blocking routine on the recovery computer to prevent virus-infected files from passing to the recovery computer. This option provides a faster recovery time, with the risk of some data loss, as virus-infected files are not recovered. Copying of the recovered data is preferably performed over the network connection to a recovery computer, to simply access to the recovered data, however, recovered data can also be copied to a hard drive connected directly to the failed computer, preferably a removable type connected via a USB connection, a FireWire connection, or similar connection.

The process of bypassing the failed computer and using the OS from the boot disk results in all the data from the failed computer being available over the network as though the failed system were a file server. Thus, access to the data on the failed system is immediate, allowing it to be copied or archived before further steps are taken to repair the system. Furthermore, the process can identify the device drivers and other system data on the failed computer to assist in the repair process.

Once the desired data has been recovered, the failed system can be put to a more thorough analysis to determine the reason for system failure, and necessary repairs, both hardware and software, can proceed. In the interim, however, the user is provided with access to time-sensitive and project-critical data that can be accessed via other, functioning computers.

This concludes the description of a presently preferred embodiment of the invention. The foregoing description has been presented for the purpose of illustration and is not intended to be exhaustive or to limit the invention to the precise form disclosed. It is intended the scope of the invention be limited not by this description but by the claims that follow.

What is claimed is:

1. A method of data recovery for a computer system, the steps comprising:
a) initializing hardware associated with the computer system, the hardware including a hard drive, and a minimum of 32 MB of RAM and a video card capable of supporting, at minimum, 16-color VGA mode;
b) initializing network devices and network connections associated with the computer system, including any available workgroups;
c) scanning and identifying partitions on any hard drives connected to the computer system;
d) recovering data from the hard drives by making all the data on the computer system available as a network share resembling a file server; and
e) copying the recovered data to a recovery hard drive.

2. The method of claim 1, wherein said method further includes a step of scanning the partitions for viruses prior to the data recovery step.

3. The method of claim 1, wherein said method further includes a step of scanning each recovered file for a virus as part of the data recovery step.

4. The method of claim 1, wherein said step of initializing the network connection proceeds automatically, without user input.

5. The method of claim 1, wherein during initialization steps a) and b), user input is solicited to confirm completion of each step.

6. The method of claim 1, wherein during initialization step b), user input is used to identify the network devices and connections.

7. The method of claim 1, wherein the recovery hard drive is provided as an external hard drive connected to a recovery computer over the network.

8. The method of claim 1, wherein the recovery hard drive is provided as a USB-connected hard drive connected directly to the computer system.

9. The method of claim 1, wherein the recovery hard drive is provided as an internal hard drive connected to a recovery computer over the network

10. The method of claim 1, wherein said scanning step c) includes scanning hard drives connected via the network connections.

11. A computer-readable storage medium storing computer-executable instructions for causing a computer system programmed thereby to perform a method of data recovery for a computer system, comprising:
a) initializing hardware associated with the computer system, the hardware including a hard drive, and a minimum of 32 MB of RAM and a video card capable of supporting, at minimum, 16-color VGA mode;
b) initializing network devices and network connections associated with the computer system, including any available workgroups;
c) scanning and identifying partitions on any hard drives connected to the computer system;
d) recovering data from the hard drives by making all the data on the computer system available as a network share resembling a file server; and
e) copying the recovered data to a recovery hard drive.

12. The computer-readable storage medium of claim 11, wherein said storage medium is selected from one of: a compact disc (CD), a DVD, a USB drive, or a combination thereof.

13. The computer-readable storage medium of claim 11, wherein said storage medium further includes boot operation instructions to enable said computer system to be booted directly from said storage medium.

14. The computer-readable storage medium of claim 11, wherein said copying step e) enables copying recovered data to a USB-connected hard drive connected directly to the computer system.

15. The computer-readable storage medium of claim 11, wherein said copying step e) enables copying recovered data to a recovery computer connected to the computer system over the network.

16. The computer-readable storage medium of claim 11, wherein said method further includes a step of scanning the partitions for viruses prior to the data recovery step.

17. The computer-readable storage medium of claim 11, wherein said method further includes a step of scanning each recovered file for a virus as part of the data recovery step.

18. The computer-readable storage medium of claim 11, wherein said step of initializing the network connection proceeds automatically, without user input.

19. The computer-readable storage medium of claim 11, wherein during initialization steps a) and b), user input is solicited to confirm completion of each step.

20. The computer-readable storage medium of claim 11, wherein during initialization step b), user input is used to identify the network devices and connections.
